(19) United States
(12) Patent Application Publication
(10) Pub. No.: US 2025/0315251 A1
(43) Pub. Date: Oct. 9, 2025

(54) DEPENDENCY RESOLUTION FOR BRANCHES IN SOFTWARE DEVELOPMENT

(71) Applicants: Benjamin Beatty, Boulder, CO (US); Michael Glen Lotz, Longmont, CO (US); Karli Devin McIntyre, Boulder, CO (US)

(72) Inventors: Benjamin Beatty, Boulder, CO (US); Michael Glen Lotz, Longmont, CO (US); Karli Devin McIntyre, Boulder, CO (US)

(73) Assignee: Ricoh Company, Ltd., Tokyo (JP)

(21) Appl. No.: 18/627,245

(22) Filed: Apr. 4, 2024

(51) Int. Cl. G06F 8/71; G06F 8/61

(52) U.S. Cl. CPC G06F 8/71; G06F 8/61

(57) ABSTRACT

Apparatus, method, and software of managing dependencies in branches. In an embodiment, a dependency manager is implemented on an automation tool communicatively coupled to a package registry that stores code packages comprising main packages and branch packages. The dependency manager is configured to expect a publish command at the automation tool to publish a branch package for a development branch of main code, identify a name of the development branch, and modify a scope in a metadata file of the branch package with the name of the development branch. In an embodiment, the dependency manager is configured to predict an install command at the automation tool to install one or more dependencies specified for the development branch, and modify each dependency in the metadata file to reference a published branch package corresponding with the dependency when a valid published branch package is found.

### TECHNICAL FIELD

The following disclosure relates to the field of software development, and more particularly, to dependency resolution of branches.

### BACKGROUND

Public or private registries may be used to store code packages that are published to the registries. Software developers may download the published code packages to use in a development project. A code package (published or unpublished) may include one or more dependencies that specify other code packages upon which the code package uses or depends. Resolution of dependencies may become difficult, especially for branches of codebases. Branching allows software developers to collaborate on a codebase by creating a branch of main code, which is a copy of the main code at a point in time. The dependencies listed in a code package of a branch (referred to herein as a branch package) typically reference the main package of the dependency (i.e., the code package for the main code). When generating a build of a branch under development (referred to as a development branch), such as for testing, a software developer has to change the source code of the development branch to reference other branch packages (if desired). Unfortunately, this does not scale well to large codebases.

### SUMMARY

Embodiments described herein provide a dependency management solution for development branches. As an overview, prior to publishing branch packages for development branches, scopes of the branch packages are modified based on the branch names. Thus, when the branch packages are subsequently published, they are published to a branch registry under their respective scoped names. Further, prior to installing dependencies for a development branch, one or more of the dependencies may be modified to reference a published branch package corresponding with the dependency (i.e., when a valid, published branch package is found). Because the branch packages are published in the branch registry according to their scoped name, the branch registry may be searched to identify branch packages that correspond with dependencies, and the dependencies may be modified to reference the branch packages. One technical benefit is a software developer does not need to manually change the dependencies or otherwise alter the source code when building a development branch. Additionally, projects may have multiple branches and each branch may have its own set of dependencies maintained and updated in isolation from other branches.

In an embodiment, a dependency manager is implemented on an automation tool communicatively coupled to a package registry that stores code packages comprising main packages and branch packages. The dependency manager comprises at least one processor and memory, and the at least one processor is configured to cause the dependency manager at least to execute a scope modification routine to: expect a publish command at the automation tool to publish a branch package for a development branch of main code to the package registry, identify a name of the development branch, and modify, prior to the publish command, a scope in a metadata file of the branch package with the name of the development branch before the publish command is executed.

In an embodiment, the at least one processor is configured to cause the dependency manager at least to execute a dependency modification routine to: predict an install command at the automation tool to install one or more dependencies specified for a development branch, and modify, prior to the install command, each dependency of the one or more dependencies in a metadata file of a branch package for the development branch to reference a published branch package corresponding with the dependency when a valid published branch package is found in the package registry.

Other embodiments may include computer readable media, other systems, or methods as described below.

The above summary provides a basic understanding of some aspects of the specification. This summary is not an extensive overview of the specification. It is intended to neither identify key or critical elements of the specification nor delineate any scope particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments of the present disclosure are now described, by way of example only, and with reference to the accompanying drawings. The same reference number represents the same element or the same type of element on all drawings.

FIG. 1 is a block diagram of a software development architecture in an illustrative embodiment.

FIG. 2 is a diagram illustrating a version control system in an illustrative embodiment.

FIG. 3 is a diagram illustrating a package registry in an illustrative embodiment.

FIG. 4 is a block diagram of a code package in an illustrative embodiment.

FIGS. 5A-5B illustrate metadata files for a code package in an illustrative embodiment.

FIG. 6A illustrates an automation tool in an illustrative embodiment.

FIG. 6B illustrates an operation of a dependency manager in relation to a build process by an automation tool in an illustrative embodiment.

FIG. 7 is a flow chart illustrating a method of managing dependencies in an illustrative embodiment.

FIG. 8 is a block diagram of a metadata file of a branch package in an illustrative embodiment.

FIG. 9 is a diagram illustrating a package registry in an illustrative embodiment.

FIG. 10 is a flow chart illustrating a method of managing dependencies in an illustrative embodiment.

FIG. 11 is a block diagram of a metadata file of a branch package in an illustrative embodiment.

FIG. 12 is a flow chart illustrating a method of modifying dependencies in an illustrative embodiment.

FIG. 13 is a diagram illustrating a version control system in an illustrative embodiment.

FIG. 14A illustrates a JSON package file in an illustrative embodiment.

FIG. 14B illustrates a modified JSON package file in an illustrative embodiment.

FIG. 15 is a diagram illustrating a package registry in an illustrative embodiment.

FIG. 16 illustrates a JSON package file in an illustrative embodiment.

FIG. 17 illustrates a modified JSON package file in an illustrative embodiment.

FIG. 18 illustrates a processing system operable to execute a computer readable medium embodying programmed instructions to perform desired functions in an illustrative embodiment.

### DETAILED DESCRIPTION

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

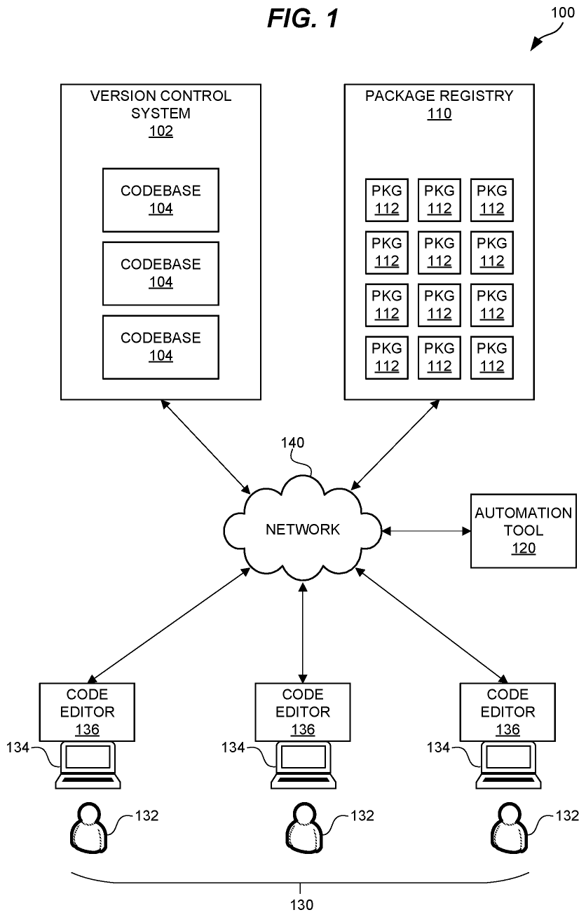

FIG. 1 is a block diagram of a software development architecture 100 in an illustrative embodiment. Software development architecture 100 comprises a collection of systems, servers, databases, and/or components used in the process of creating, designing, testing, and/or deploying software products. A software product is typically developed in collaboration by a group or team 130 of software developers 132. Software developers 132 utilize Personal Computers (PC), laptops, etc., which are generally referred to as workstations 134, to create, update/modify, and/or delete code for software products, such as with a code editor 136 (i.e., an integrated development environment (IDE) application).

In an embodiment, software development architecture 100 includes a version control system 102 and a package registry 110. Version control system 102 (VCS) is a software tool configured to track and/or manage changes to code. Version control system 102 provides a repository (e.g., hosted locally on a server, on network-attached storage, remotely on a cloud platform, etc.) for codebases 104 of one or more projects. A codebase 104 comprises a complete body of source code for a software program, application, project, etc. Version control system 102 is configured to track changes made to codebases 104 over time, and take a snapshot of each modification. For example, a codebase 104 comprises the main code that is tested and stable, and may be live or already deployed. Instead of directly editing the main code to update or change the codebase 104, a software developer 132 may create a branch (i.e., a copy or clone) of the main code through version control system 102 and edit the branch. When the edits to the branch are complete, the software developer 132 may save or commit the branch to the version control system 102. When the branch is tested and/or otherwise verified, the branch may be merged into the main code. Version control system 102 assists in branching off branches of the main code, merging branches back into the main code, maintaining a history of changes to branches/main code (e.g., the changes made to code, when the changes were made, who made the changes, etc.), etc. Some examples of version control system 102 include GitHub, GitLab, Beanstalk, AWS CodeCommit, etc.

Package registry 110 (also referred to generally as a registry) is a digital storage and retrieval facility for code packages 112 (also referred to generally herein as packages or artifacts). Package registry 110 provides one or more registries (e.g., hosted locally on a server, on network-attached storage, remotely on a cloud platform, etc.) for the code packages 112. A code package 112 is a file or directory comprising source code and associated metadata describing dependencies and/or other information regarding the code package 112. A code package 112, which is tested or otherwise verified, may be published in package registry 110 to create a library of code packages 112. This allows for code packages 112 to be shared amongst the software development team 130. Package registry 110 may be a public registry or a private registry. One example of package registry 110 is JFrog, although other types of registries are considered herein.

Software development architecture 100 further comprises an automation tool 120. Automation tool 120 may comprise a continuous integration or continuous delivery (CI/CD) tool configured to build and/or test software products. One example of automation tool 120 is Jenkins, although other types of automation tools are considered herein, such as Github Actions, AWS CodeBuild, etc.

Systems of software development architecture 100 are communicatively coupled, such as over a network 140. The network 140 may comprise, for example, a network including a local area network (LAN), a wide area network (WAN), such as the Internet, etc., and may comprise a wired network, a wireless network, or a network including both of a wired network and a wireless network.

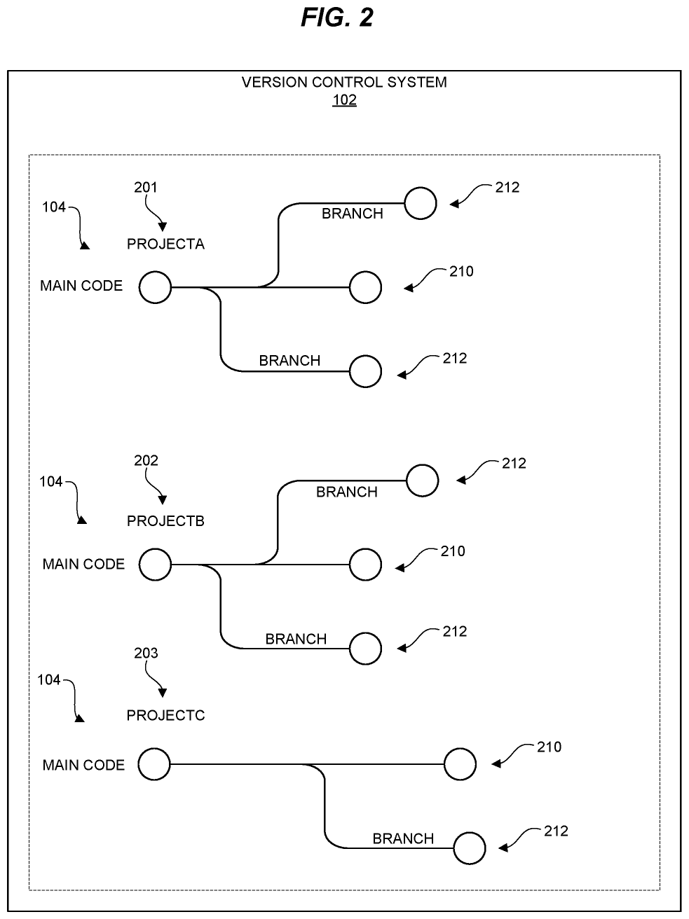

FIG. 2 is a diagram illustrating the version control system 102 in an illustrative embodiment. In this example, version control system 102 manages a plurality of projects 201-203, referred to generally as ProjectA, ProjectB, and ProjectC. A project 201-203 is a collection of source code/files, build scripts, and/or other resources that are used to develop and deploy a software product or application. One example of a project 201-203 is a JavaScript project, although other languages are considered herein. The codebase 104 (i.e., source code) for each project 201-203 includes main code 210 (also referred to as the mainline, trunk, or simply “main”), which is the code that is tested, and ready for production or is in production (i.e., “live” code). A codebase 104 may also include one or more branches 212, which is a copy of the main code 210 that can be modified separately from the main code 210 and/or other branches 212. Code branching allows a software development team 130 to work on different portions of a project 201-203 in parallel, and separates untested or “in-progress” work from the tested and stable main code 210. When a branch 212 is subsequently tested and ready for production, the branch 212 may be merged into the main code 210 based on a merging strategy.

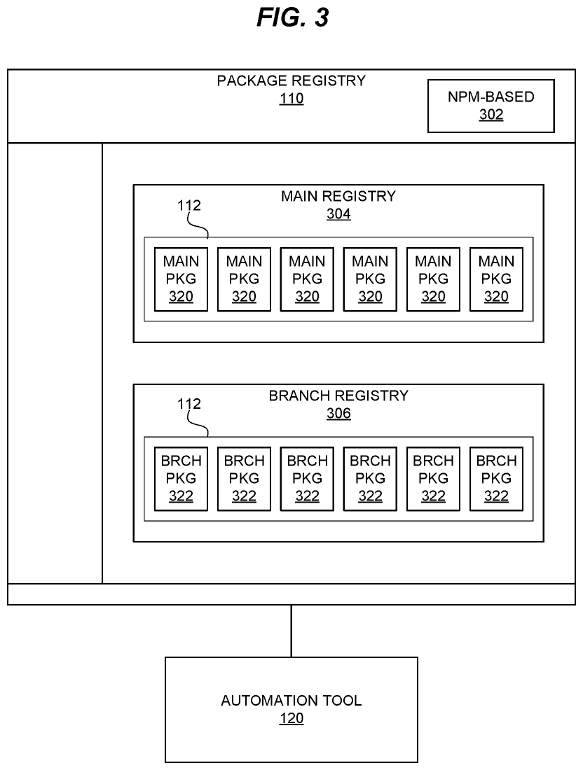

FIG. 3 is a diagram illustrating the package registry 110 in an illustrative embodiment. Package registry 110 is configured to store and/or manage code packages 112. In an embodiment, package registry 110 is provisioned with a main registry 304 and a branch registry 306. Main registry 304 is configured to store and/or manage code packages 112 related to or associated with main code 210, which may be referred to as main packages 320. Branch registry 306 is configured to store and/or manage code packages 112 related to or associated with branches 212, which may be referred to as branch packages 322. Automation tool 120 is communicatively coupled to package registry 110, such as to publish branch packages 322 to branch registry 306. Thus, automation tool 120 is configured with an instruction or command set for package registry 110, an Applicant Programming Interface (API), etc. In an embodiment, package registry 110 may comprise an npm-based registry 302. In general, node package manager (npm) is a package manager and a software register where developers are able to find, build, and manage code packages 112. An npm-based registry 302 includes a command line client used for managing code packages 112, which operates based on a command set including npm install, npm run build, npm publish, etc.

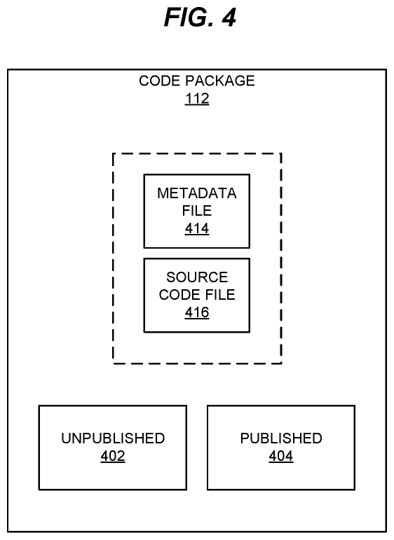

FIG. 4 is a block diagram of a code package 112 in an illustrative embodiment. In general, a code package 112 includes a metadata file 414 describing the code package 112, and one or more source code files 416 comprising the source code for the code package 112. A code package 112 may be an unpublished code package 402 meaning that the code package has not been published to the package registry 110, or may be a published code package 404 meaning that the code package has been published to the package registry 110. For example, an unpublished code package 402 may comprise a branch package 322 in development that has not yet been published to the package registry 110 until built and tested. A published code package 404 may comprise a main package 320 or a branch package 322 that has been published to the package registry 110 after being tested or otherwise verified.

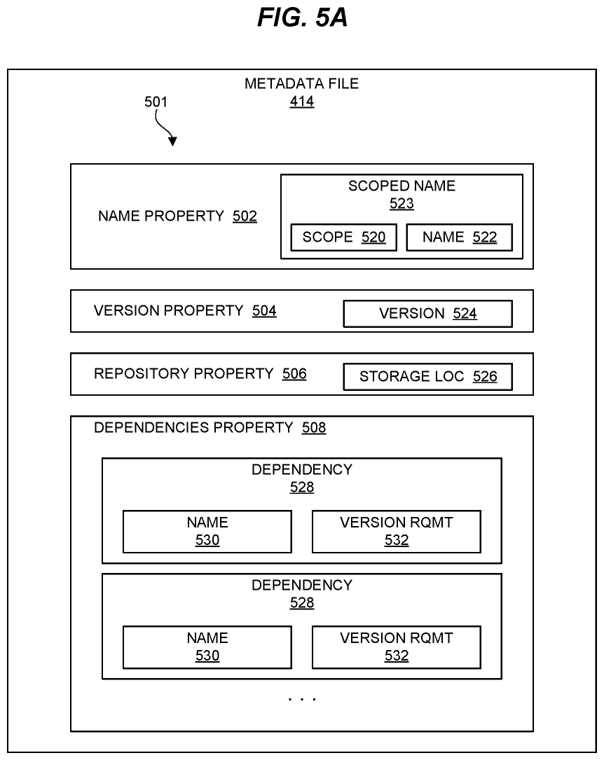

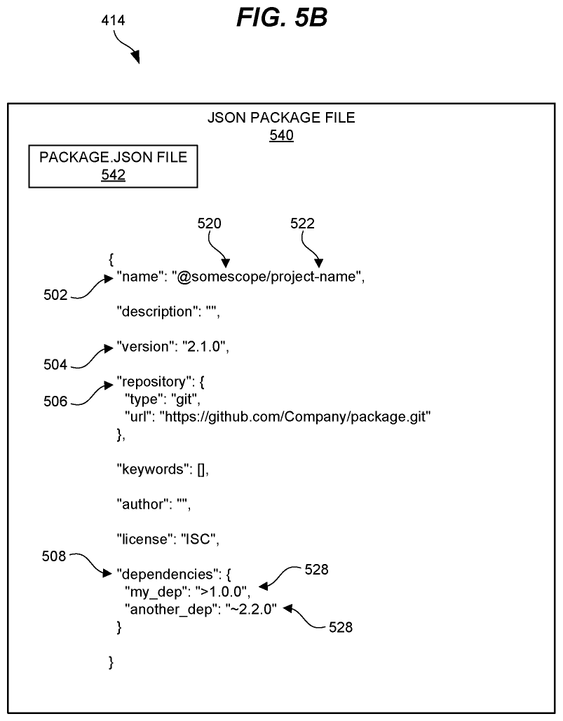

FIGS. 5A-5B illustrate metadata files 414 for a code package 112 in an illustrative embodiment. In FIG. 5A, a metadata file 414, in general, includes properties 501 or fields that store information regarding a code package 112, such as a name property 502, a version property 504, a repository property 506, and a dependencies property 508, although other properties 501 are considered herein. One example of a metadata file 414 is a JavaScript Object Notation (JSON) package file 540 (e.g., “package.json” file 542), an example of which is illustrated in FIG. 5B. In FIG. 5A, the name property 502 is a string that indicates the name 522 of a project and a scope 520, which combine to form a scoped name 523. A scope 520 is a way of grouping related packages together. The scope 520 is a prefix to the name 522 preceded by an “@” symbol and followed by a slash (i.e., “/” symbol). For example, a scoped name 523 may be “@somescope/<Project name>” or the like. The version property 504 denotes the current version 524 of the code package 112 described in the metadata file 414. The repository property 506 describes a storage location 526 where the source code for the code package 112 is stored or published. For example, storage location 526 may comprise a Uniform Resource Locator (URL) of a repository. The dependencies property 508 specifies other code packages upon which the code package 112 uses or depends, which are referred to as dependencies 528. Each dependency 528 in the dependencies property 508 includes the name 530 and version requirements 532 of the dependency 528. The version requirements 532 may specify a specific version or a range of versions. For example, in FIG. 5B, one dependency 528 includes a version requirement 532 of “>1.0.0”, which indicates that the version of the dependency 528 (i.e., “my_dep”) must be greater than version “1.0.0”. Another dependency 528 includes a version requirement 532 of “˜2.2.0”, which indicates that the version of the dependency 528 (i.e., “another_dep”) must be approximately equivalent to version “2.2.0”.

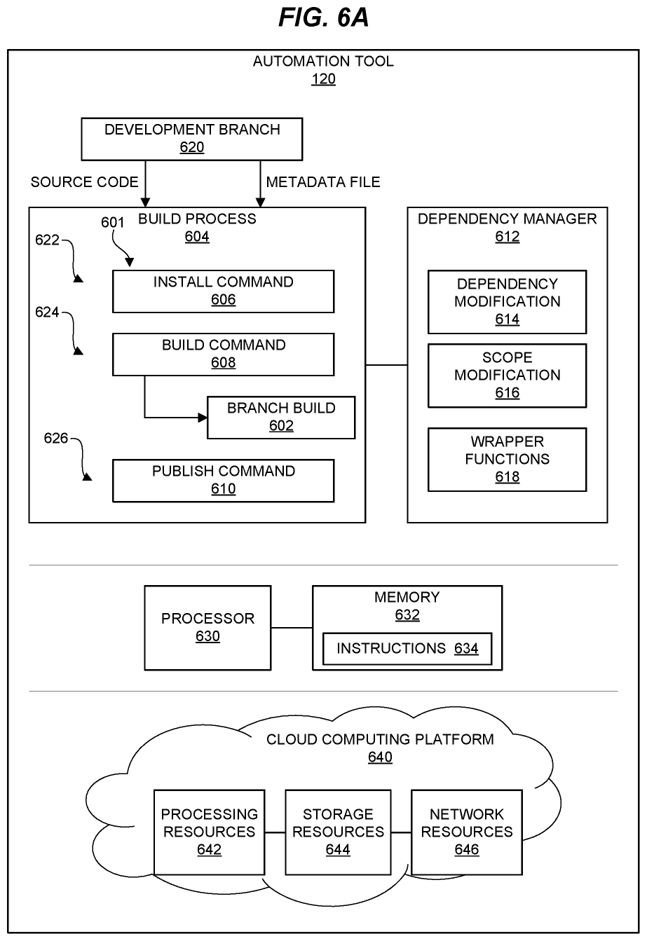

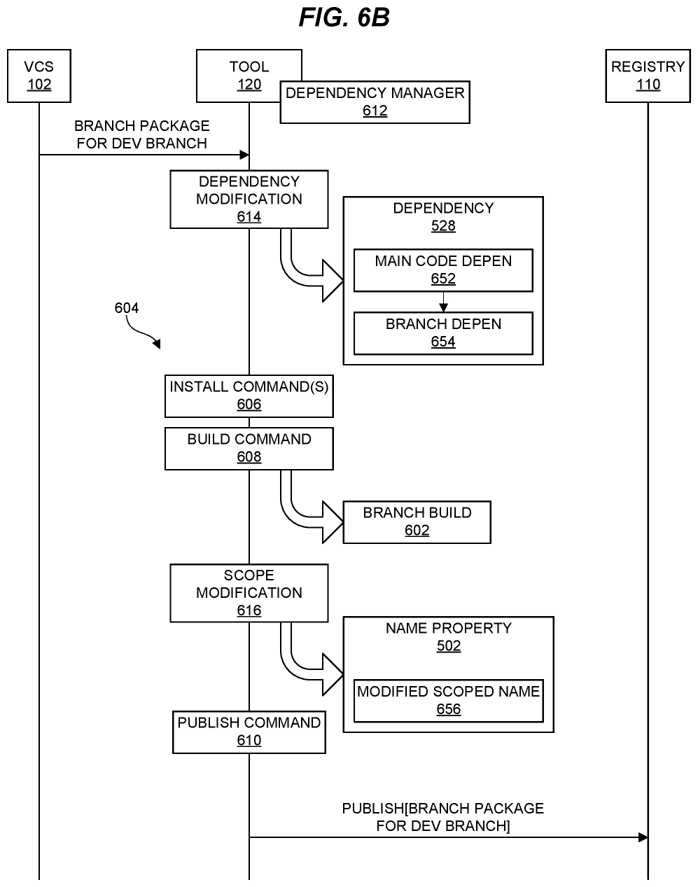

FIG. 6A illustrates automation tool 120 in an illustrative embodiment. As described above, automation tool 120 is configured to build and/or test software products. In an embodiment, automation tool 120 implements or provides a build process 604 (automated) for code. More particularly, automation tool 120 is configured to automatically create a branch build 602 for a branch 212 of a codebase 104. Automation tool 120 may be further configured to test the branch build 602 after creation. For the build process 604, automation tool 120 is configured to perform a sequence of commands 601. One command 601 is an install command 606, which installs a package and any packages that it depends on in an install phase 622. One example of the install command 606 is an npm install command. Another command 601 is a build command 608, which creates a build directory with a production build (i.e., branch build 602) of the branch in a build phase 624. One example of the build command 608 is an npm run build command. Another command 601 is a publish command 610, which publishes a package to a package registry 110 in a publish phase 626, so that the package can be installed by name. One example of the publish command 610 is an npm publish command.

As an example of the build process 604, automation tool 120 may receive or retrieve a branch package 322 for a branch 212 under development, which may be generally referred to as a development branch 620. Thus, automation tool 120 may receive or retrieve source code (or changes to source code) for the development branch 620, may receive or retrieve a metadata file 414 associated with the development branch 620, etc. In the install phase 622, the automation tool 120 processes the metadata file 414 associated with the development branch 620 to determine any dependencies 528 for the development branch 620, and executes an install command(s) 606 (e.g., npm install command) to install the dependencies 528 (i.e., install published code packages 404 for the dependencies 528). After installing any dependencies 528 for the development branch 620, automation tool 120 enters a build phase 624 and executes a build command 608 (e.g., npm run build command) to create a build directory with a branch build 602 of the development branch 620. The branch build 602 may then be tested. When testing is complete on the branch build 602 and successful, automation tool 120 enters a publish phase 626 and executes a publish command 610 (e.g., npm publish command) to publish the branch package 322 for the development branch 620 to the branch registry 306 in package registry 110.

In embodiments described herein, a dependency manager 612 is implemented in the software development architecture 100. Dependency manager 612 is an information processing apparatus comprising circuitry, logic, hardware, an application, means, software, etc., configured to oversee or supervise the build process 604. More particularly, dependency manager 612 is configured to perform a scope modification routine 616 associated with a publish command 610 or publish phase 626 at automation tool 120. The scope modification routine 616 is a routine, program, script, or other component of a software application configured to automatically trigger or initiate prior to a publish command 610 in automation tool 120. With the scope modification routine 616, prior to publishing a branch package 322 for a development branch 620 to the branch registry 306 via a publish command 610, dependency manager 612 modifies a scope 520 of the branch package 322 to include the name of the development branch 620. An effect of modifying the scope 520 is that the branch package 322 will be published to the branch registry 306 instead of the main registry 304, and will be indexed by the name of the development branch 620. One technical benefit of performing the scope modification routine 616, such as for multiple branch packages 322, is the branch packages 322 are searchable as dependencies 528 for other development branches 620. For example, if a branch build 602 includes a dependency 528 that references a main package 320 of a project 201-203, the branch package 322 of the project 201-203 is searchable in the branch registry 306, and may be installed as the dependency 528 in place of the main package 320.

Dependency manager 612 is configured to perform a dependency modification routine 614 associated with an install command 606 or install phase 622 at automation tool 120. The dependency modification routine 614 is a routine, program, script, or other component of a software application configured to automatically trigger or initiate prior to an install command 606 in automation tool 120. With the dependency modification routine 614, prior to installing dependencies 528 for a development branch 620 at automation tool 120 via install commands 606, dependency manager 612 searches branch registry 306 for a valid branch package 322 associated with the dependency 528, and causes automation tool 120 to install the branch package 322 of the dependency 528 rather than the main package 320 associated with the dependency 528. One technical benefit is automation tool 120 may automatically install the branch packages 322 of dependencies 528 (if existing) for a development branch 620, and builds the development branch 620 with the branch packages 322 so that the branch build 602 includes the features of the branch packages 322. And, a software developer 132 does not need to manually change the dependencies 528 or otherwise alter the source code of the development branch 620 to include the features of the branch packages 322. This allows the software developer 132 to install and use branch dependencies in an isolated way, while also saving them from the overhead that would normally be required to do so. Because the web or chain of dependencies 528 can grow to be quite large in certain cases, automating this work ends up saving a massive amount of developer time and energy.

Dependency manager 612 may be built on top of automation tool 120, such as one or more wrapper functions 618. A wrapper function 618 is used to extend the behavior of the wrapped function, such as the build process 604. The platform of automation tool 120 (and consequently, the dependency manager 612) may be implemented on a hardware platform comprised of analog and/or digital circuitry. The platform of automation tool 120 may be implemented on a processor 630 that executes instructions 634 stored in memory 632. A processor 630 comprises an integrated hardware circuit configured to execute instructions 634 to provide the functions of automation tool 120. Processor 630 may comprise a set of one or more processors or may comprise a multi-processor core, depending on the particular implementation. Memory 632 is a non-transitory computer readable medium for data, instructions, applications, etc., and is accessible by processor 630. Memory 632 is a hardware storage device capable of storing information on a temporary basis and/or a permanent basis. Memory 632 may comprise a random-access memory, or any other volatile or non-volatile storage device.

The platform of automation tool 120 may be implemented on a cloud computing platform 640 (e.g., Amazon Web Services (AWS), Google Cloud, Microsoft Azure, etc.) or another type of processing platform. Cloud resources provisioned on cloud computing platform 640 may comprise processing resources 642 (e.g., physical or hardware processors, a server, a virtual server or virtual machine (VM), a virtual central processing unit (vCPU), etc.), storage resources 644 (e.g., physical or hardware storage, virtual storage, etc.), and/or networking resources 646, although other resources are considered herein.

FIG. 6B illustrates an operation of dependency manager 612 in relation to a build process 604 by automation tool 120 in an illustrative embodiment. In an embodiment, automation tool 120 receives or retrieves a branch package 322 (e.g., unpublished) for a development branch 620, such as from version control system 102. In response, automation tool 120 implements a build process 604 (automated) for the development branch 620. For the build process 604, automation tool 120 performs a sequence of commands 601 comprising one or more install commands 606, a build command 608, and a publish command 610.

Install commands 606 are used by automation tool 120 to install any dependencies 528 indicated in the metadata file 414 of the development branch 620. Prior to the install command(s) 606, dependency manager 612 runs or executes the dependency modification routine 614 to potentially modify dependencies 528 in the metadata file 414. For example, a dependency 528 in the metadata file 414 may reference, indicate, or point to a main package 320, which may be referred to as a main code dependency 652. Dependency manager 612 searches branch registry 306 for a branch package 322 (i.e., a published code package 404) associated with the dependency 528 (i.e., associated with the main package 320), and may modify the dependency 528 to reference the branch package 322 instead of the main package 320. Thus, the main code dependency 652 may be changed to a branch dependency 654 that references, indicates, or points to a branch package 322 (i.e., a published code package 404). The dependency modification routine 614 may therefore modify one or more of the dependencies 528 in the metadata file 414 to branch dependencies 654. When automation tool 120 subsequently executes the install commands 606 for the dependencies 528, main packages 320 and/or branch packages 322 may be installed depending on whether a dependency 528 is a main code dependency 652 or a branch dependency 654.

After installing any dependencies 528 for the development branch 620, automation tool 120 executes a build command 608 to create a build directory with a branch build 602 of the development branch 620. The branch build 602 may then be tested. When testing is complete on the branch build 602 and successful, automation tool 120 is configured to execute a publish command 610. The publish command 610 is used by automation tool 120 to publish the branch package 322 for the development branch 620 to the branch registry 306. Prior to the publish command 610, dependency manager 612 runs or executes the scope modification routine 616 to modify the scope 520 of the branch package 322 to include the name of the development branch 620. Thus, the name property 502 of the metadata file 414 includes a modified scoped name 656 that includes the name of the development branch 620.

When automation tool 120 subsequently executes the publish command 610, the branch package 322 for the development branch 620 is published to the branch registry 306. Due to the modified scoped name 656, the branch package 322 will be indexed by the name of the development branch 620. Further, the branch package 322 may be published with one or more branch dependencies 654 depending on whether branch dependencies 654 were found via the dependency modification routine 614.

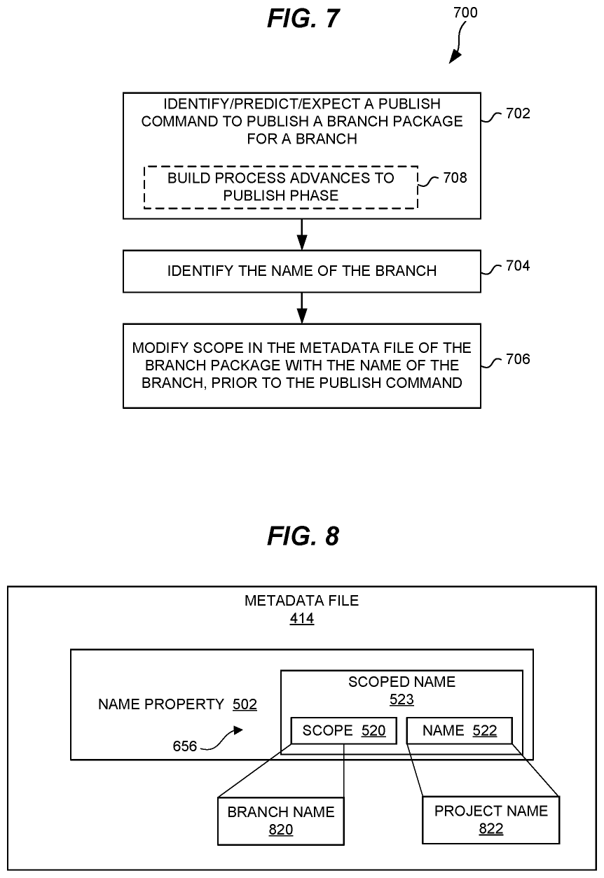

FIG. 7 is a flow chart illustrating a method 700 of managing dependencies in an illustrative embodiment. The steps of method 700 will be described with reference to dependency manager 612 in FIG. 6A, but those skilled in the art will appreciate that method 700 may be performed in other systems or devices. Also, the steps of the flow charts described herein are not all inclusive and may include other steps not shown, and the steps may be performed in an alternative order.

Method 700 describes the scope modification routine 616 executed or performed by dependency manager 612. The scope modification routine 616 is performed in the publish phase 626 of the build process 604, and prior to execution of a publish command 610. Dependency manager 612 predicts, expects, or identifies a publish command 610 to publish a branch package 322 for a development branch 620 (step 702). For example, dependency manager 612 may expect a publish command 610 when the build process 604 for the development branch 620 advances to the publish phase 626 (optional step 708), such as after the build phase 624. Dependency manager 612 identifies the name of the development branch 620 (step 704), and modifies, changes, or edits the scope 520 or scoped name 523 in the metadata file 414 of the branch package 322 with the name of the development branch 620 before the publish command 610 is executed (step 706).

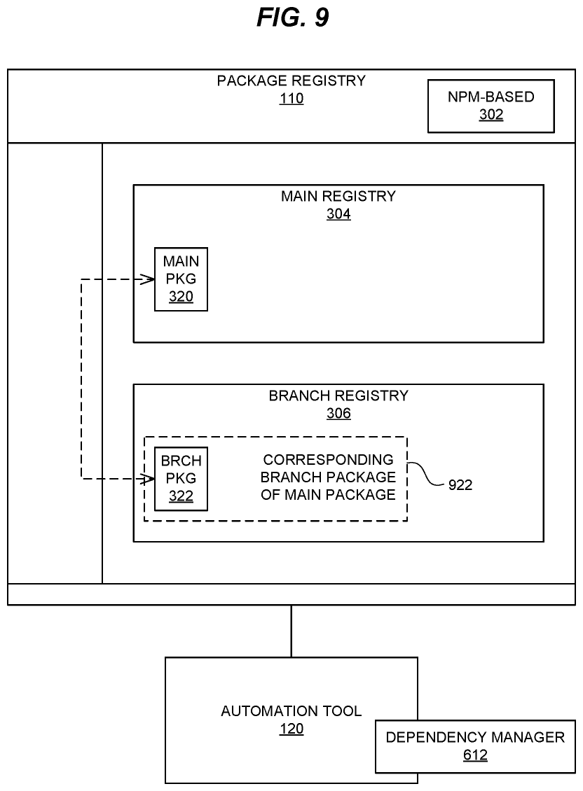

FIG. 8 is a block diagram of the metadata file 414 of the branch package 322 in an illustrative embodiment. As described in FIG. 5A, the metadata file 414 includes a name property 502 comprising a scoped name 523 that indicates a name 522, which may be the project name 822 of the project associated with the development branch 620, and a scope 520. Dependency manager 612 modifies, changes, or edits the scope 520 with the branch name 820 of the development branch 620. The name property 502 therefore has a modified scoped name 656 including the branch name 820 of the development branch 620 and any other scope (e.g., “somescope”) prefixed to the name 522 (e.g., project name 822 associated with the development branch 620). Thus, when automation tool 120 subsequently executes a publish command 610 for the branch package 322 of the development branch 620, the branch package 322 will publish to the branch registry 306 instead of the main registry 304 according to the modified scoped name 656 of the branch package 322. FIG. 9 is a diagram illustrating the package registry 110 in an illustrative embodiment. When automation tool 120 executes the publish command 610 for the branch package 322 of the development branch 620, the branch package 322 will be published to the branch registry 306 instead of the main registry 304 according to the modified scoped name 656 of the branch package 322. The branch package 322 is related to, is associated with, or corresponds with a main package 320, as the development branch 620 is a branch 212 of main code 210. The branch package 322 may therefore be referred to as a corresponding branch package 922. One technical benefit is the branch package 322 will be searchable as a dependency 528 for other development branches 620 sharing the same branch name 820.

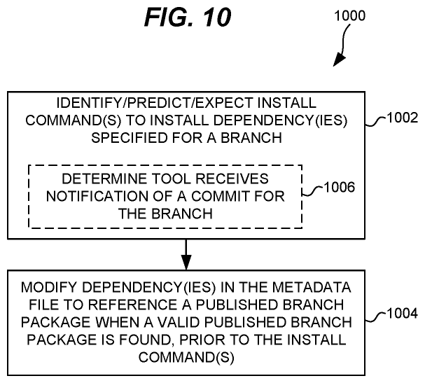

FIG. 10 is a flow chart illustrating a method 1000 of managing dependencies in an illustrative embodiment. The steps of method 1000 will be described with reference to dependency manager 612 in FIG. 6A, but those skilled in the art will appreciate that method 1000 may be performed in other systems or devices. Method 1000 describes the dependency modification routine 614 executed or performed by dependency manager 612. The dependency modification routine 614 is performed in the install phase 622 of the build process 604, and prior to execution of an install command(s) 606. Dependency manager 612 predicts, expects, or identifies one or more install commands 606 to install one or more dependencies 528 specified for the development branch 620 (step 1002). For example, automation tool 120 may be configured to receive a notification (e.g., a webhook) if/when a commit operation is issued to the version control system 102 regarding the development branch 620. Dependency manager 612 determines that automation tool 120 receives the notification of the commit operation, and predicts or expects that one or more install commands 606 are forthcoming in response to the notification as part of the build process 604 (optional step 1006). Dependency manager 612 modifies, changes, or edits the dependencies 528 (if any) in the metadata file 414 of the branch package 322 to a branch dependency 654 that references a published branch package 322 when a valid published branch package 322 is found in the package registry 110 (step 1004). Criteria used to define a “valid” published branch package 322 may vary as desired. In an embodiment, a published branch package 322 is considered valid for a dependency 528 when the name of the published branch package 322 matches the name of the development branch 620, and the published branch package 322 satisfies the version requirement 532 for the dependency 528. After modification of any dependencies 528 as in step 1004, the install command(s) 606 may be executed by automation tool 120.

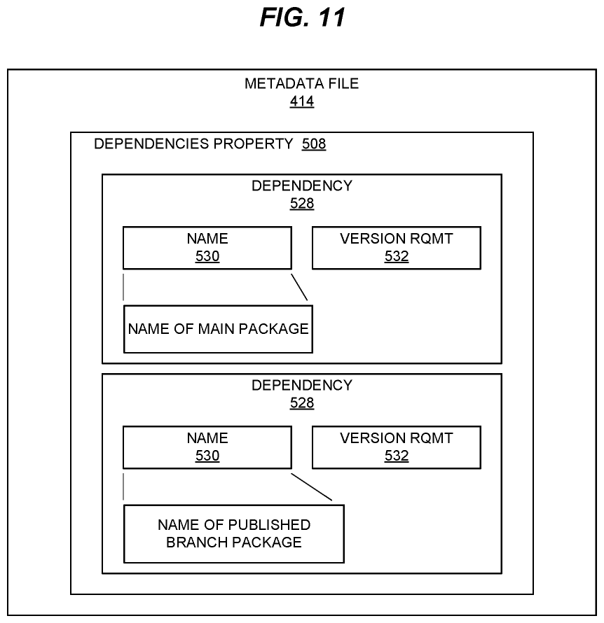

FIG. 11 is a block diagram of the metadata file 414 of the branch package 322 in an illustrative embodiment. As described in FIG. 5A, the metadata file 414 includes a dependencies property 508 that indicates one or more dependencies 528. For each dependency 528 specified for the development branch 620, dependency manager 612 searches the branch registry 306 for a valid published branch package 322 (i.e., corresponding branch package 922) that meets the requirements of the dependency 528. When a valid published branch package 322 is found in the branch registry 306, dependency manager 612 modifies the dependency 528 in the metadata file 414 to reference the published branch package 322. For the example in FIG. 11, dependency manager 612 did not find a valid published branch package 322 for the first dependency 528, so the name 530 of the dependency 528 remains as the name of the main package 320 (as originally specified in the dependency 528). Dependency manager 612 did find a valid published branch package 322 for the second dependency 528, so the name 530 of the dependency 528 is changed to the name of the published branch package 322. One technical benefit is certain dependencies 528 of a development branch 620 will be changed to reference a published branch package 322 so that the development branch 620 is built with other branch packages 322 that share the same branch name.

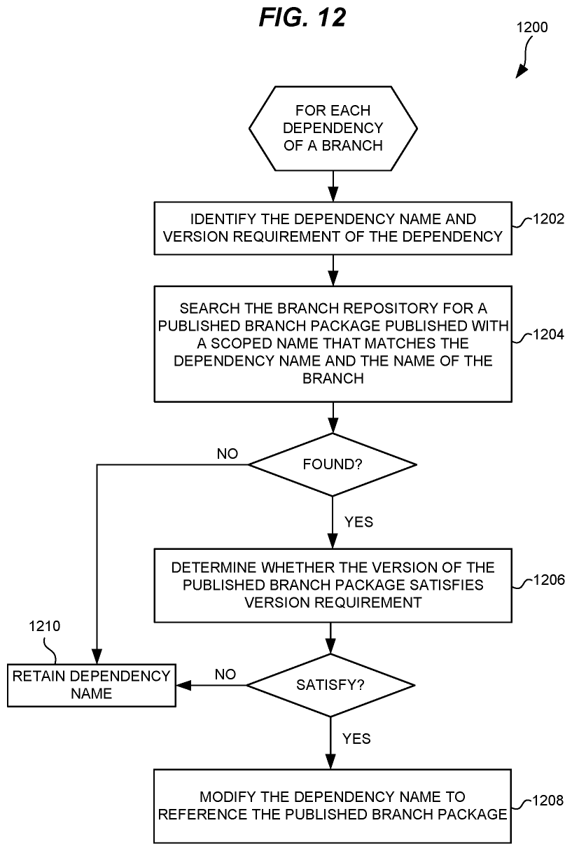

FIG. 12 is a flow chart illustrating a method 1200 of modifying dependencies 528 in an illustrative embodiment. The steps of method 1200 may further describe step 1004 in FIG. 10. Dependency manager 612 processes the metadata file 414 for the development branch 620 to identify one or more dependencies 528 specified in the dependencies property 508. For each dependency 528, dependency manager 612 identifies the dependency name 530 and version requirement 532 of the dependency 528 (step 1202). Dependency manager 612 searches the branch registry 306 for a published branch package 322 published with a modified scoped name 656 that matches the dependency name 530 and the branch name 820 of the development branch 620 (step 1204). When a published branch package 322 is found, dependency manager 612 determines whether the version 524 of the published branch package 322 satisfies the version requirement 532 (step 1206). When the version 524 of the published branch package 322 satisfies the version requirement 532, a valid published branch package 322 is found. Thus, dependency manager 612 modifies the dependency name 530 to reference the published branch package 322 instead of the main package 320 (step 1208). When a published branch package 322 is not found or a version 524 of a published branch package 322 does not satisfy the version requirement 532, dependency manager 612 retains the dependency name 530 (step 1210). One technical benefit is dependency manager 612 is able to cycle through the dependencies 528 of a development branch 620 and modify the dependencies 528 to branch dependencies 654 when applicable.

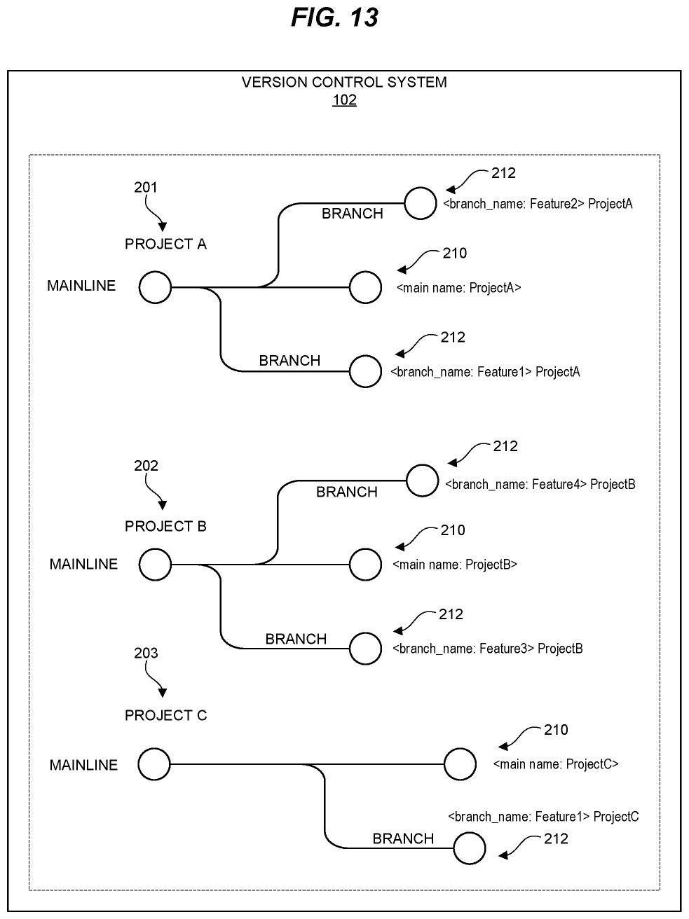

FIGS. 13-17 illustrate an example of the dependency modification routine 614 and the scope modification routine 616. FIG. 13 is a diagram illustrating the version control system 102 in an illustrative embodiment. In this example, version control system 102 again manages a plurality of projects 201-203, referred to generally as ProjectA, ProjectB, and ProjectC. ProjectA includes a first branch 212 having the name “Feature1”, and a second branch 212 having the name “Feature2”. ProjectB includes a first branch 212 having the name “Feature3”, and a second branch 212 having the name “Feature4”. ProjectC includes a branch 212 having the name “Feature1” (i.e., same name as the first branch 212 in ProjectA).

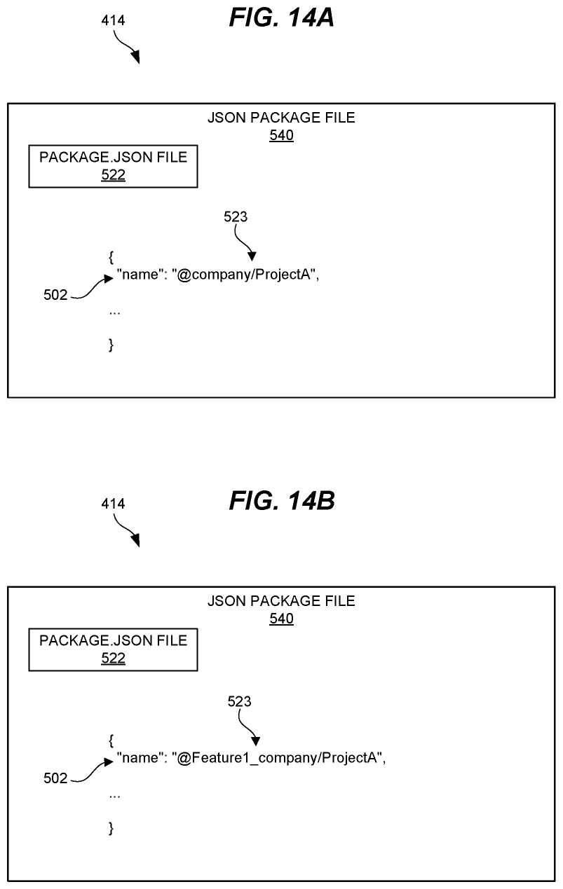

To perform the scope modification routine 616, prior to publishing a branch package 322 for a development branch 620 to the branch registry 306 via a publish command 610, dependency manager 612 modifies the scope 520 of the branch package 322 to include the branch name 820 of the development branch 620. Assume, for example, that the development branch 620 comprises the first branch 212 of ProjectA. FIGS. 14A-14B illustrate JSON package files 540 (e.g., “package.json” file 542) in an illustrative embodiment. FIG. 14A shows an example of the JSON package file 540 before the scope modification routine 616, where the scoped name 523 comprises “@company/ProjectA”. For the scope modification routine 616, dependency manager 612 modifies the scope 520 of the JSON package file 540 for the first branch 212 of ProjectA to include the name of the first branch 212 (i.e., Feature1). FIG. 14B shows an example of the JSON package file 540 after modification by the scope modification routine 616. Dependency manager 612 adds the name of the first branch 212 (i.e., Feature1) to the scoped name 523, so the scoped name 523 now comprises “@Feature1_company/ProjectA”. In an embodiment, dependency manager 612 may prefix the branch name 820 to any other scope of the scoped name 523 (e.g., “company”). An effect of modifying the scope 520 or scoped name 523 is that the branch package 322 will publish to the branch registry 306 instead of the main registry 304 when automation tool 120 executes the install command 610. Dependency manager 612 performs the scope modification routine 616 prior to publishing branch packages 322 for other branches 212 in a similar manner. It is noted that the dependency modification routine 614 is also performed, but that description is omitted at this time to illustrate how the scope modification routine 616 is used in relation to multiple branch packages 322 being published to the package registry 110.

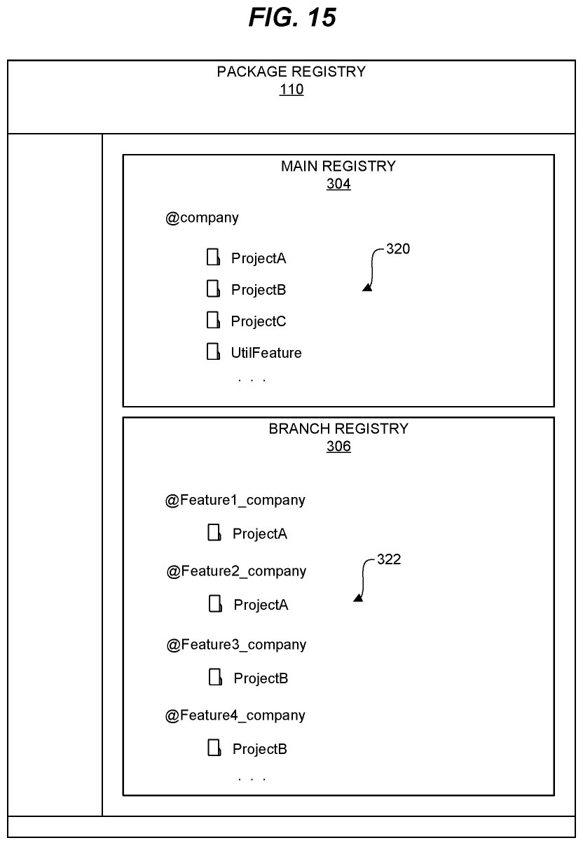

FIG. 15 is a diagram illustrating the package registry 110 in an illustrative embodiment. Package registry 110 is provisioned with a main registry 304 and a branch registry 306. Main registry 304 is configured to store and/or manage main packages 320, while branch registry 306 is configured to store and/or manage branch packages 322. As illustrated in FIG. 15, the main registry 304 stores main packages 320 for @company/ProjectA, @company/ProjectB, @company/ProjectC, and also stores other main packages 320, such as for “@company/UtilFeature”. After performing the scope modification routine 616 for the first branch 212 of ProjectA (having the name “Feature1”), the second branch 212 of ProjectA (having the name “Feature2”), the first branch 212 of ProjectB (having the name “Feature3”), and the second branch 212 of Project B (having the name “Feature4”), branch registry 306 stores branch packages 322 for Feature1 of ProjectA as @Feature1_company/ProjectA, Feature2 of ProjectA as @Feature2_company/ProjectA, Feature3 of ProjectB as @Feature3_company/ProjectB, and Feature4 of ProjectB as @Feature4_company/ProjectB. One technical benefit is the branch packages 322 with modified scope 520 are published to the branch registry 306 and indexed by their name so they are searchable as a dependency 528.

To perform the dependency modification routine 614, prior to installing dependencies 528 for a development branch 620 via install commands 606, dependency manager 612 searches branch registry 306 for a valid published branch package 322 corresponding with a dependency 528, and causes automation tool 120 to install the published branch package 322 of the dependency 528 rather than the main package 320 of the dependency 528 when a valid published branch package 322 is found. To do so, when dependency manager 612 finds a branch package 322 (i.e., published) that matches the branch name 820 of the development branch 620 and satisfies the version requirement 532 of the dependency 528, dependency manager 612 modifies the dependency name 530 to reference the branch package 322 rather than the main package 320.

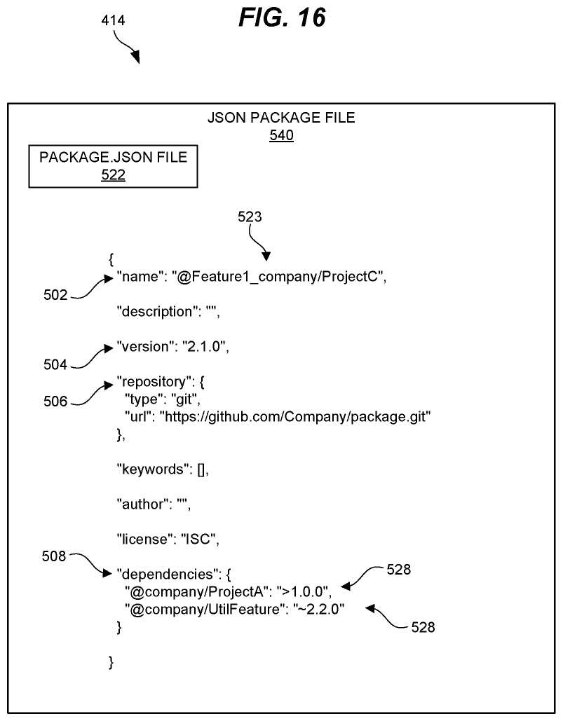

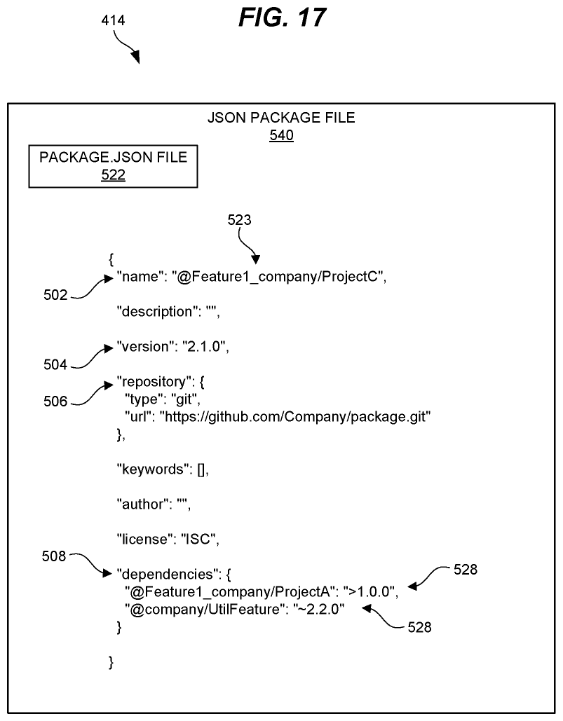

Assume, for example, the development branch 620 is the branch 212 of ProjectC with the branch name 820 of Feature1, as shown in FIG. 13. FIG. 16 illustrates a JSON package file 540 in an illustrative embodiment. The JSON package file 540 shown in FIG. 16 is for the branch 212 of ProjectC, and includes two dependencies 528: a first dependency 528 to “@company/ProjectA”, and a second dependency 528 to “@company/UtilFeature”. For the first dependency 528 (“@company/ProjectA”), dependency manager 612 searches the branch registry 306 for a branch package 322 that matches the name 530 of the dependency 528 (i.e., “@company/ProjectA”) and the branch name 820 of the development branch 620 (i.e., “Feature1”). In this example, dependency manager 612 locates a branch package 322 that matches (as illustrated in FIG. 15) and satisfies the version requirement 532, so dependency manager 612 modifies the dependency name 530 to reference the branch package 322. FIG. 17 illustrates a modified JSON package file 540 in an illustrative embodiment. The modified JSON package file 540 shown in FIG. 17 is again for the branch 212 of ProjectC (i.e., Feature1 branch). Dependency manager 612 modifies the dependency name 530 of the first dependency 528 (“@company/ProjectA”) to reference the branch package 322 (i.e., “@Feature1_company/ProjectA”). For the second dependency 528 (“@company/UtilFeature”), dependency manager 612 searches the branch registry 306 for a branch package 322 that matches the name 530 of the dependency 528 (i.e., “@company/UtilFeature”) and the branch name 820 of the development branch 620 (i.e., “Feature1”). In this example, dependency manager 612 does not locate a branch package 322 that matches both, so dependency manager 612 retains the dependency name 530 of “@company/UtilFeature”. One technical benefit is when automation tool 120 subsequently executes install commands 606 for the two dependencies 528 based on the modified JSON package file 540 as in FIG. 17, the automation tool 120 will automatically install the branch package 322 (i.e., “Feature1_company/ProjectA”) instead of the main package 320 (“@company/ProjectA”). Thus, the subsequent build of the development branch 620 (i.e., Feature1 of ProjectC) will include features in Feature1 of ProjectA. This allows a software developer 132 to use changes to the branch package 322 “Feature1_ProjectA” in the build of the development branch 620 (i.e., Feature1 branch of ProjectC), with minimal overhead to the software developer 132. This isolation ensures a predictable, controlled environment for developing and testing a group of projects.

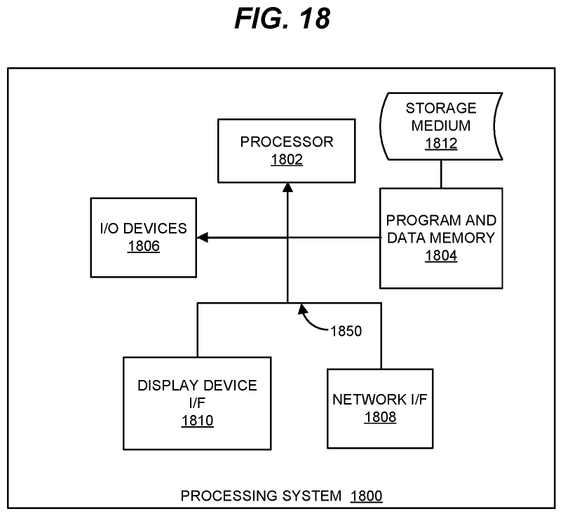

Embodiments disclosed herein can take the form of software, hardware, firmware, or various combinations thereof. FIG. 18 illustrates a processing system 1800 operable to execute a computer readable medium embodying programmed instructions to perform desired functions in an illustrative embodiment. Processing system 1800 is operable to perform the above operations by executing programmed instructions tangibly embodied on computer readable storage medium 1812. In this regard, embodiments can take the form of a computer program accessible via computer-readable medium 1812 providing program code for use by a computer or any other instruction execution system. For the purposes of this description, computer readable storage medium 1812 can be anything that can contain or store the program for use by the computer.

Computer readable storage medium 1812 can be an electronic, magnetic, optical, electromagnetic, infrared, or semiconductor device. Examples of computer readable storage medium 1812 include a solid-state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

Processing system 1800, being suitable for storing and/or executing the program code, includes at least one processor 1802 coupled to program and data memory 1804 through a system bus 1850. Program and data memory 1804 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 1806 (including but not limited to keyboards, displays, pointing devices, etc.) can be coupled either directly or through intervening I/O controllers. Network adapter interfaces 1808 may also be integrated with the system to enable processing system 1800 to become coupled to other data processing systems or storage devices through intervening private or public networks. Modems, cable modems, IBM Channel attachments, SCSI, Fibre Channel, and Ethernet cards are just a few of the currently available types of network or host interface adapters. Display device interface 1810 may be integrated with the system to interface to one or more display devices, such as printing systems and screens for presentation of data generated by processor 1802.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system according to embodiments and examples described herein.

Some embodiments pertain to Example 1 that includes an apparatus comprising a dependency manager implemented on an automation tool communicatively coupled to a package registry that stores code packages comprising main packages and branch packages. The dependency manager comprises at least one processor and memory. The at least one processor is configured to cause the dependency manager at least to execute a scope modification routine to expect a publish command at the automation tool to publish a branch package for a development branch of main code to the package registry, identify a name of the development branch, and modify, prior to the publish command, a scope in a metadata file of the branch package with the name of the development branch before the publish command is executed.

Example 2 includes the subject matter of Example 1, where the metadata file comprises a JavaScript Object Notation package file.

Example 3 includes the subject matter of Examples 1 and 2, where the at least one processor is further configured to cause the dependency manager at least to expect the publish command at the automation tool when a build process for the development branch advances to a publish phase.

Example 4 includes the subject matter of Examples 1-3, where the at least one processor is further configured to cause the dependency manager at least to execute a dependency modification routine to predict an install command at the automation tool to install one or more dependencies specified for the development branch, and modify, prior to the install command, each dependency of the one or more dependencies in the metadata file to reference a published branch package corresponding with the dependency when a valid published branch package is found in the package registry.

Example 5 includes the subject matter of Examples 1-4, where the at least one processor is further configured to cause the dependency manager at least to determine that the automation tool receives a notification of a commit operation issued to a version control system for the development branch, and predict the install command based on the notification.

Example 6 includes the subject matter of Examples 1-5, where the package registry comprises a main registry that stores the main packages and a branch registry that stores the branch packages. The at least one processor is further configured to cause the dependency manager at least to execute the dependency modification routine to, for each dependency of the one or more dependencies: identify a dependency name and a version requirement of the dependency, search the branch registry for a published branch package published with a scoped name that matches the dependency name and matches a branch name of the development branch, determine, when a published branch package is found that matches the dependency name and the branch name of the development branch, whether a version of the published branch package satisfies the version requirement, and modify, when the version satisfies the version requirement, the dependency name to reference the published branch package.

Example 7 includes the subject matter of Examples 1-6, where the at least one processor is further configured to cause the dependency manager at least to retain the dependency name for the dependency when a published branch package is not found that matches the branch name of the development branch and satisfies the version requirement.

Some embodiments pertain to Example 8 that includes a method comprising, in a dependency manager implemented on an automation tool communicatively coupled to a package registry that stores code packages comprising main packages and branch packages, expecting a publish command at the automation tool to publish a branch package for a development branch of main code to the package registry, identifying a name of the development branch, and modifying, prior to the publish command, a scope in a metadata file of the branch package with the name of the development branch before the publish command is executed.

Example 9 includes the subject matter of Example 8, where the metadata file comprises a JavaScript Object Notation package file.

Example 10 includes the subject matter of Examples 8 and 9, where the expecting comprises expecting the publish command at the automation tool when a build process for the development branch advances to a publish phase.

Example 11 includes the subject matter of Examples 8-10, further comprising predicting an install command at the automation tool to install one or more dependencies specified for the development branch, and modifying, prior to the install command, each dependency of the one or more dependencies in the metadata file to reference a published branch package corresponding with the dependency when a valid published branch package is found in the package registry.

Example 12 includes the subject matter of Examples 8-11, where the predicting comprises determining that the automation tool receives a notification of a commit operation issued to a version control system for the development branch.

Example 13 includes the subject matter of Examples 8-12, where the package registry comprises a main registry that stores the main packages and a branch registry that stores the branch packages. The modifying each dependency of the one or more dependencies in the metadata file comprises, for each dependency of the one or more dependencies: identifying a dependency name and a version requirement of the dependency, searching the branch registry for a published branch package published with a scoped name that matches the dependency name and matches a branch name of the development branch, determining, when a published branch package is found that matches the dependency name and the branch name of the development branch, whether a version of the published branch package satisfies the version requirement, and modifying, when the version satisfies the version requirement, the dependency name to reference the published branch package.

Example 14 includes the subject matter of Examples 8-13, further comprising retaining the dependency name for the dependency when a published branch package is not found that matches the branch name of the development branch and satisfies the version requirement.

Some embodiments pertain to Example 15 that includes a computer readable medium embodying programmed instructions executed by a processor, wherein the instructions direct the processor to implement a method comprising, in a dependency manager implemented on an automation tool communicatively coupled to a package registry that stores code packages comprising main packages and branch packages, expecting a publish command at the automation tool to publish a branch package for a development branch of main code to the package registry, identifying a name of the development branch, and modifying, prior to the publish command, a scope in a metadata file of the branch package with the name of the development branch.

Example 16 includes the subject matter of Example 15, where the metadata file comprises a JavaScript Object Notation package file.

Example 17 includes the subject matter of Examples 15 and 16, where the expecting comprises expecting the publish command at the automation tool when a build process for the development branch advances to a publish phase.

Example 18 includes the subject matter of Examples 15-17, where the method further comprises predicting an install command at the automation tool to install one or more dependencies specified for the development branch, and modifying, prior to the install command, each dependency of the one or more dependencies in the metadata file to reference a published branch package corresponding with the dependency when a valid published branch package is found in the package registry.

Example 19 includes the subject matter of Examples 15-18, where the predicting comprises determining that the automation tool receives a notification of a commit operation issued to a version control system for the development branch.

Example 20 includes the subject matter of Examples 15-19, where the package registry comprises a main registry that stores the main packages and a branch registry that stores the branch packages. The modifying each dependency of the one or more dependencies in the metadata file comprises, for each dependency of the one or more dependencies: identifying a dependency name and a version requirement of the dependency, searching the branch registry for a published branch package published with a scoped name that matches the dependency name and matches a branch name of the development branch, determining, when a published branch package is found that matches the dependency name and the branch name of the development branch, whether a version of the published branch package satisfies the version requirement, and modifying, when the version satisfies the version requirement, the dependency name to reference the published branch package.

Although specific embodiments were described herein, the scope of the invention is not limited to those specific embodiments. The scope of the invention is defined by the following claims and any equivalents thereof.

What is claimed is:

1. An apparatus, comprising:
a dependency manager implemented on an automation tool communicatively coupled to a package registry that stores code packages comprising main packages and branch packages;
the dependency manager comprises at least one processor and memory;
the at least one processor is configured to cause the dependency manager at least to execute a scope modification routine to:
expect a publish command at the automation tool to publish a branch package for a development branch of main code to the package registry;
identify a name of the development branch; and
modify, prior to the publish command, a scope in a metadata file of the branch package with the name of the development branch before the publish command is executed.

2. The apparatus of claim 1, wherein:
the metadata file comprises a JavaScript Object Notation package file.

3. The apparatus of claim 1, wherein the at least one processor is further configured to cause the dependency manager at least to:
expect the publish command at the automation tool when a build process for the development branch advances to a publish phase.

4. The apparatus of claim 1, wherein the at least one processor is further configured to cause the dependency manager at least to execute a dependency modification routine to:
predict an install command at the automation tool to install one or more dependencies specified for the development branch; and
modify, prior to the install command, each dependency of the one or more dependencies in the metadata file to reference a published branch package corresponding with the dependency when a valid published branch package is found in the package registry.

5. The apparatus of claim 4, wherein the at least one processor is further configured to cause the dependency manager at least to:
determine that the automation tool receives a notification of a commit operation issued to a version control system for the development branch, and predict the install command based on the notification.

6. The apparatus of claim 4, wherein:
the package registry comprises a main registry that stores the main packages and a branch registry that stores the branch packages; and
the at least one processor is further configured to cause the dependency manager at least to execute the dependency modification routine to:
for each dependency of the one or more dependencies:
identify a dependency name and a version requirement of the dependency;
search the branch registry for a published branch package published with a scoped name that matches the dependency name and matches a branch name of the development branch;
determine, when a published branch package is found that matches the dependency name and the branch name of the development branch, whether a version of the published branch package satisfies the version requirement; and
modify, when the version satisfies the version requirement, the dependency name to reference the published branch package.

7. The apparatus of claim 6, wherein the at least one processor is further configured to cause the dependency manager at least to:
retain the dependency name for the dependency when a published branch package is not found that matches the branch name of the development branch and satisfies the version requirement.

8. A method, comprising:
in a dependency manager implemented on an automation tool communicatively coupled to a package registry that stores code packages comprising main packages and branch packages,
expecting a publish command at the automation tool to publish a branch package for a development branch of main code to the package registry;
identifying a name of the development branch; and
modifying, prior to the publish command, a scope in a metadata file of the branch package with the name of the development branch before the publish command is executed.

9. The method of claim 8, wherein:
the metadata file comprises a JavaScript Object Notation package file.

10. The method of claim 8, wherein the expecting comprises:
expecting the publish command at the automation tool when a build process for the development branch advances to a publish phase.

11. The method of claim 8, further comprising:
predicting an install command at the automation tool to install one or more dependencies specified for the development branch; and
modifying, prior to the install command, each dependency of the one or more dependencies in the metadata file to reference a published branch package corresponding with the dependency when a valid published branch package is found in the package registry.

12. The method of claim 11, wherein the predicting comprises:
determining that the automation tool receives a notification of a commit operation issued to a version control system for the development branch.

13. The method of claim 11, wherein:
the package registry comprises a main registry that stores the main packages and a branch registry that stores the branch packages; and
the modifying each dependency of the one or more dependencies in the metadata file comprises:
for each dependency of the one or more dependencies:
identifying a dependency name and a version requirement of the dependency;
searching the branch registry for a published branch package published with a scoped name that matches the dependency name and matches a branch name of the development branch;
determining, when a published branch package is found that matches the dependency name and the branch name of the development branch, whether a version of the published branch package satisfies the version requirement; and
modifying, when the version satisfies the version requirement, the dependency name to reference the published branch package.

14. The method of claim 13, further comprising:
retaining the dependency name for the dependency when a published branch package is not found that matches the branch name of the development branch and satisfies the version requirement.

15. A computer readable medium embodying programmed instructions executed by a processor, wherein the instructions direct the processor to implement a method comprising:
in a dependency manager implemented on an automation tool communicatively coupled to a package registry that stores code packages comprising main packages and branch packages,
expecting a publish command at the automation tool to publish a branch package for a development branch of main code to the package registry;
identifying a name of the development branch; and
modifying, prior to the publish command, a scope in a metadata file of the branch package with the name of the development branch.

16. The computer readable medium of claim 15, wherein:
the metadata file comprises a JavaScript Object Notation package file.

17. The computer readable medium of claim 15, wherein the expecting comprises:
expecting the publish command at the automation tool when a build process for the development branch advances to a publish phase.

18. The computer readable medium of claim 15, wherein the method further comprises:
predicting an install command at the automation tool to install one or more dependencies specified for the development branch; and
modifying, prior to the install command, each dependency of the one or more dependencies in the metadata file to reference a published branch package corresponding with the dependency when a valid published branch package is found in the package registry.

19. The computer readable medium of claim 18, wherein the predicting comprises:
determining that the automation tool receives a notification of a commit operation issued to a version control system for the development branch.

20. The computer readable medium of claim 18, wherein:
the package registry comprises a main registry that stores the main packages and a branch registry that stores the branch packages; and
the modifying each dependency of the one or more dependencies in the metadata file comprises:
for each dependency of the one or more dependencies:
identifying a dependency name and a version requirement of the dependency;
searching the branch registry for a published branch package published with a scoped name that matches the dependency name and matches a branch name of the development branch;
determining, when a published branch package is found that matches the dependency name and the branch name of the development branch, whether a version of the published branch package satisfies the version requirement; and
modifying, when the version satisfies the version requirement, the dependency name to reference the published branch package.
